(19) United States
(12) Patent Application Publication
(10) Pub. No.: US 2003/0033203 A1
(43) Pub. Date: Feb. 13, 2003

(54) Point management system

(76) Inventors: Masayuki Inoue, Fujisawa-shi (JP); Koichi Yoneta, Yokohama-shi (JP); Tetsuharu Inamitsu, Chigasaki-shi (JP); Shigeyuki Itoh, Zushi-shi (JP); Yutaka Takami, Yokohama-shi (JP); Kenji Matsumoto, Yokohama-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/268,996

(22) Filed: Oct. 11, 2002

Related U.S. Application Data
(63) Continuation of application No. 09/258,302, filed on Feb. 26, 1999.

(30) Foreign Application Priority Data
Mar. 3, 1998 (JP) P10-050404

(51) Int. Cl. G06F 17/60; A63F 9/24; A63F 13/00; G06F 17/00; G06F 19/00

(52) U.S. Cl. 705/14; 463/17

(57) ABSTRACT

A system is provided to manage points provided by plural manufacturers and plural stores using one card. To achieve this object, the point management system has a point system management apparatus that administers the whole point system, a reading and writing apparatus which reads and writes the data from/into an IC card, and an IC card which ha a memory having plurality of point record areas that store point data transmitted from the reading and writing apparatus and a point management application that controls access to the point record area of the memory.

The present application is a continuation of application Ser. No. 09/258,302, filed Feb. 26, 1999, the contents of which are incorporated herein by reference

### BACKGROUND OF THE INVENTION

This invention relates to a system that manages points that are issued when goods are purchased. Especially, this invention relates to a system that manages points by using an IC card.

It is well known that points are given to a customer according to the amount of goods or services purchased, and the customer then gets an award, such as reduction of the price of a future purchase or receives a gift, according to the number of points collected by the customer. There are some concrete methods described below of such a system.

In one method, a customer collects points by sticking a stamp, like a service ticket or a coupon ticket attached to the goods, onto a pasteboard. The service ticket and the coupon ticket are given to the customer at the time of paying for a purchase, or are attached to the goods. When the points collected exceed a predetermined number of points, the customer can be given an award, such as a discount, or receive a gift by redeeming the points. In the case of sticking a service ticket on a pasteboard, most customers don't carry the pasteboard with them, and so they must carry the service ticket back to their home and stick it onto the pasteboard. This service ticket is so small that the customer often loses it. In the case of stamping points on a pasteboard, if the customer doesn't carry the pasteboard at the time of shopping, a store cannot stamp the points. The store responds to that case by the following methods. The store issues a new pasteboard, or stamps points on a receipt to assure that the points will be stamped on a pasteboard during the next visit to the store by the customer. In case of issuing a new pasteboard, the points on several pasteboards sometimes cannot be summarized with one pasteboard.

There is also a system of issuing a magnetic stripe card or an IC card to a customer. The number of points earned is recorded on these cards whenever the customer is shopping. A merit of this system is that a pasteboard is not necessary and points or records of use are stored not only on the card, but also in an apparatus for reading and writing from/into the cards. In a point managing system using a pasteboard, there is no help when a customer loses his or her pasteboard. However, in this system, a customer has the advantage that it is possible to reissue a card and to fill in the past record by using the memory of the apparatus. A manufacturer and a store have the added advantage that customer management is enabled, and points and records of use can be used as information for setting up a sales promotion.

Other than the above-explained cards, a card having a bar code also is used. In case a bar code is used, points are stored in a reading and writing apparatus of the store and administered centrally. The points cannot be managed on a card. The customer's benefit in using a bar code reader is the same as that of using a magnetic or an IC card, at the point of using the card.

In the systems mentioned above, even in a system that uses a card, many manufacturers and stores tend to operate their own original system using a special card that does not have compatibility with the cards of other systems. But it is troublesome for a customer to always carry all of the cards required for each of the stores that the customer frequents. In addition, a customer may forget to bring the card required for a particular stamping point system. And, when there is a need to upgrade the system in the store or introduce a POS system or other system, it becomes necessary to manage many customers. As to introduction of a system on which costs are managed like the above-explained system, a method of using a multifunctional telephone has been described in the Japanese Patent Laid-open Publication 6-96096 and 6-110905.

Further, a point management system in the case of shopping with a credit card is available. In this system, points are sent with the use specification to the customer later. A customer sticks a point stamp on a pasteboard sent to the customer by a centralized system. This system has the advantage that points are certainly sent to a customer. However, this system can deal only with points issued by the credit card company. Thus, this system cannot deal with points issued by a manufacturer or a store. It is not practical that the store perform the same service, because the cost of sending the points to each customer is expensive. The typical manufacturer and store provide a service by issuing points to a customer using the various conventional methods that have been explained above. Therefore, the customer has a problem of having to manage many kinds of pasteboards and cards. And, the points are sometimes used by a method that is in common among related manufacturers and related stores, located on a particular shopping street, etc. This requires a system which is able to manage the requirements of every store even if points are commonly controlled and applied. On the other hand, the points collected on a pasteboard or a postal card are used for exchange into goods, or for receiving goods by drawing lots other than using the points in the store.

### SUMMARY OF THE INVENTION

An object of the present invention is to solve the above problems and to manage points provided by plural manufacturers and plural stores using one card.

A further object of the present invention is to manage points commonly issued in related stores, besides individual points provided by each manufacturer and each store.

Still another object of the present invention is to send points by a managing facility by transmitting points that are stored on a card.

To achieve the above objects, the point management system of this invention includes a point system management apparatus that administers the whole point system, a reading and writing apparatus which reads and writes the data from/into an IC card, and an IC card which has a memory having a plurality of point record areas that store point data transmitted from the reading and writing apparatus and a point management application that controls access to a point record area of the memory assigned to a particular entity.

The point system management apparatus registers and controls the point data for each manufacturer that operates a point system, and issues a cryptograph key to access the point management application that is peculiar to every manufacturer at the time of registering. The reading and writing apparatus reads and writes the point data that is issued according to a customer's use by using the cryptograph key sent from the point system management apparatus. This cryptograph key is a key peculiar to each manufacturer, or is a key in which a cryptograph key is combined other information, such as a manufacturer code. The point management application records points in an area within the several point record areas by identifying this information. The point management application is independent from the manufacturers, and the point management application can be used commonly for all manufacturers and stores registered to the point system management apparatus and independently manages each point total. The point management application allows reading and writing only of the data in the area that corresponds to a key which is received.

It is also proposed that several different point applications for each stores may be installed for use on an IC card having multiple applications. According to the present invention, a point application manages points of several stores commonly, providing the following effects. When one common point application is installed, other point applications become unnecessary. Therefore program duplication can be prevented and an IC card can be used efficiently. Furthermore in the case of managing points by using several point management applications, instructions to the application as to which data store is to be used must be provided from the outside. According to the invention, the need to specify to the application which store is to be used can be deleted because the application automatically determines an area to store point data by using the one application. In addition, there is a problem that it is difficult or impossible to combine points when points are managed in separate applications. If a single application manages points in common, a group of points into which the points of some stores have been integrated can be easily created. And, service that integrates the points of several stores only for a certain term can be easily done.

### BRIEF DESCRIPTION OF THE DRAWING

These and other features, objects and advantages of the present invention will become more apparent from the following description when taken in conjunction with the accompanying drawings wherein:

FIG. 1 is a block diagram showing a first preferred embodiment of the point management system of the present invention.

FIG. 2 is a block diagram showing the structure of the memory of the IC card that is used for the first preferred embodiment.

FIG. 3 is a block diagram showing a second preferred embodiment of the point management system of the present invention.

FIG. 4 is a block diagram showing a third preferred embodiment of the point management system of the present invention.

FIG. 5 is a block diagram showing a fourth preferred embodiment of the point management system of the present invention.

FIG. 6 is a block diagram showing a fifth preferred embodiment of the point management system of the present invention.

### DETAILED DESCRIPTION OF PREFERRED EMBODIMENTS

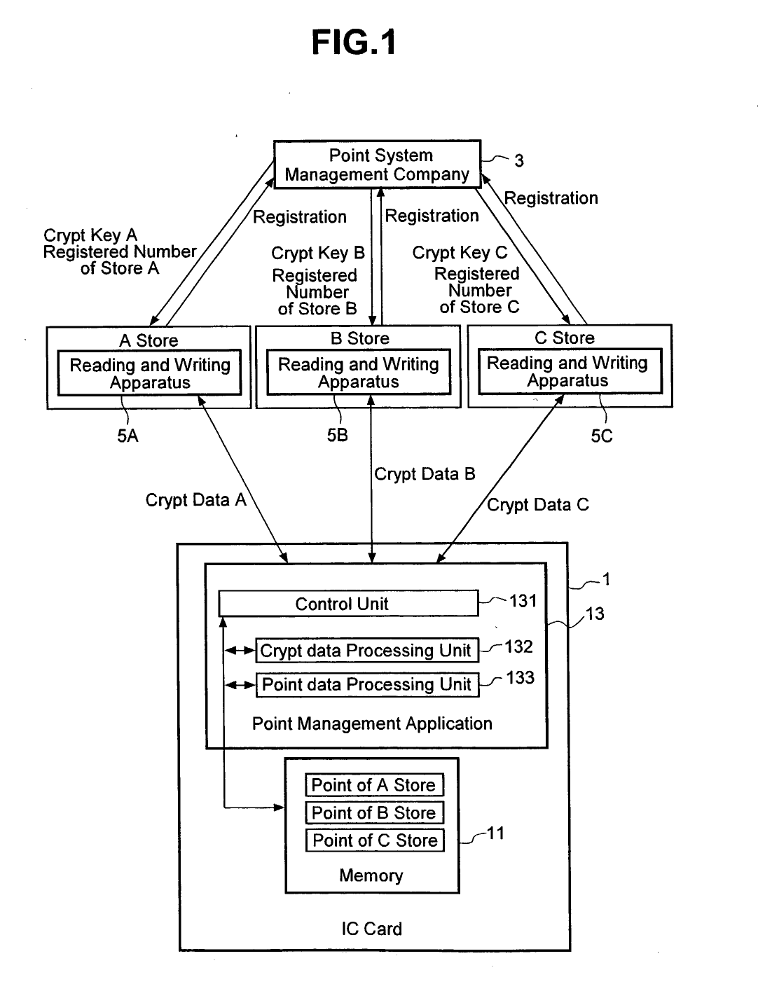

FIG. 1 shows the overall structure of a point management system representing a first embodiment of the present invention, This point management system includes a customer's IC card 1 that has a point management application 13, a point system management company 3 and a reading and writing apparatus 5 set up in a store participating in this system. The IC card 1 has a memory 11 and the point management application 13 provided by the point system management company 3. For example, the point management application 13 may be in the form of a software program.

The point management application 13 has at least the following two functions. The first function is cryptographic processing based on key data that is used when accessing the application 13. The second function is recording points in the memory 11. For this purpose, the point management application 13 has a control unit 131, a cryptograph processing unit 132 and a point data processing unit 133. A reading and writing apparatus 5 can be accessed by the point management application 13 by using respective key data send by several manufacturers or combined data including key data and one or more other data items provided by several manufacturers. The point management application 13 has a function allowing reading and writing of data only from/into a point storage area corresponding to the received key data.

The point system management company 3 has a point system management apparatus administering the whole point system. This point system management apparatus functions to control and register information for the store A, the store B and the store C, respectively, and issues key data that represents a particular key for each store. When the point management application 13 to be described later is used, this key data is used. A cryptograph key and a registration store number are returned as key data in this embodiment. Unitary management of a registration store number and a cryptograph key by the point system management company 3 can prevent the issuing of a duplicated registration store number and cryptograph key.

A respective reading and writing apparatus 5A, 5B and 5C set up in each store functions in response to the IC card 1 and the point management application 13 stored in the IC card 1. In order to register point data in the point system management company 3 and to be given a service in the store A that uses the point system of this company, the customer is issued the IC card 1 having a cryptograph key A provided from the point system management company 3. For a customer to receive points from the store A, the IC card 1 of the customer is inserted in the reading and writing apparatus 5A of the store A. At this time, the reading and writing apparatus 5A sends encrypted data to the point management application 13, which is accessed using the cryptograph key A and a registration store number read out from the card. The crypt data processing unit 132 decrypts the encrypted data sent according to a rule predetermined by the point system management company 3 in advance. The control unit 131 determines whether the accessed store is a registered member or not based on the decrypt data, and obtains a registration store number.

If this IC card 1 has been used in the past in this store, a point storage area corresponding to the registration store number is already secured in the memory 11. If the IC card 1 is being used in this store for the first time, the point management application 13 secures a storage area to store the point data of the store A newly in the memory 11. The store A can access the point storage area assigned to that store by the above procedure for reading and writing point data. The point data is sent from the reading and writing apparatus 5A to the point management application 13 with a command for adding points to the stored total for the customer. The point data processing unit adds new point data to the point data that already exists. The control unit 131 restores the processed point data in the point storage area corresponding to the transmitted encrypted data.

In case points are used by a customer, the number of points to be withdrawn is sent from the reading and writing apparatus 5A to the point management application 13 with a command for subtracting points from the stored total. And then, this application 13 stores the point data that results when the required points are subtracted from the point total that previously existed. Similar to the store A, the store B and the store C access the point management application 13 by using a cryptograph key and a registration store number and manage point data, respectively. The point management application 13 will prohibit a mingling of the point data of the stores because access is allowed only to the storage area that corresponds to a registration store number when this application is accessed.

As explained above, it is possible for the management of points of several stores to be effected using one common IC card. The following represent some examples of the application of this system. In one case the management company 3 is a participating entity, and the store 5 is a participating store that can use the card of a credit card company. In another case, the management company 3 is a cooperative union in a shopping district, and the store 5 is a member of the union. In a further case, the management company 3 is the parent company of a group of companies, and the store 5 is a related company, for example, a supermarket, or a toy store. In still another case, the management company 3 is a petroleum company and the store 5 is a gas station. In a still further case, the management company 3 is a soft drink manufacturer, and the store 5 is a vending machine. In another case, the management company 3 is a company that manages airline companies, the store 5 is one such airline-company and the points represent airline mileage. There may be other various situations for which this system may be used.

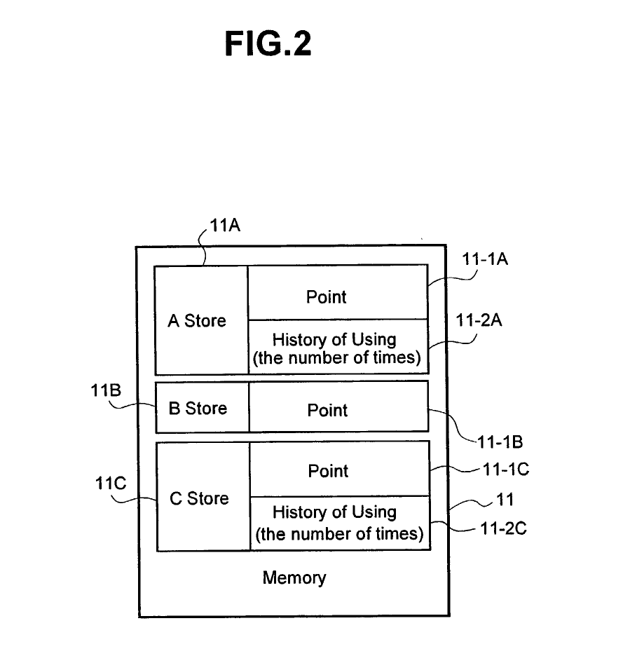

By reference to FIG. 2, the storage structure of memory 6 in the case of a modified first preferred embodiment will be explained. In this embodiment, areas 11-2A and 11-2C, which store the history of use in addition to accumulated points, are secured in storage areas 11A for the store A and 11C for the store C. In particular, respective storage areas 11A, 11B and 11C are secured for each store in memory 6. Each storage area of a store has the store's code, the area 11-1 storing point data and the area 11-2 storing the history of use according to necessity. It is possible to provide a storage area having a history of use area (like the store A and the store C) and a storage area that does not have a history of use area (like the store B) in one card by using a flag, etc.

The procedure performed for access of each store to the point management application 13 using the IC card is similar to the first preferred embodiment. For the store A, the reading and writing apparatus 5A sends point data to the point management application 13 to write a point amount similar to the first embodiment. At this time, the point management application 13 updates the point data total of the point storage area 11-1A of the store A and adds one to the history of use storage area 11-2A. However, nothing is added concerning history of use when points are subtracted at the time the customer redeems points. A grasp of the number of times a customer uses the card is made possible regardless of the residual quantity of points according to the above function. This function can eliminate the problem that the number of times a customer uses the card cannot be known simply from the point total because the point total is reduced when points are redeemed, and so the IC card can be used for customer management.

To perform this function, the reading and writing apparatus 5 transmits a new command with which to access the history of use storage area, or the point management application manages an access area with a number to be subtracted. The reading and writing apparatus 5 can operate on data independently of the requirements of the point management application 13. And, several storage areas for storing a point total for every store can be secured in the case of expanding the system further. For example, the points accumulated in a limited term and normally accumulated points can be separately managed.

And, in case the point management application 13 is accessed, a method which allows only reading is also possible, as well as a method of not allowing the points of other stores to be accessed at all, as described above. By doing this, the point total of another storage area can be confirmed at a store nearby, which is an advantage for the customer.

And, by providing a key to read the point total of all stores in common, confirmation of a point balance is enabled by using all of the apparatuses that can read an IC card. If the electronic money held by an IC card spreads, an apparatus to confirm a balance in the card spreads into an individual person. To confirm the balance, the IC card reading and writing apparatus that can be connected to a personal computer in a home can be used. Therefore, without going to a store, the customer can easily confirm a point balance.

A cryptograph can be simplified depending on its necessity. For example, if the key data that each store has issued individually is used in common, the cryptograph can be simplified. If an IC card is accessed by the combination of a common key and a registration store number, even if the key data is common, a store can be identified. If this is used only in a small and closed area, it is possible to apply it.

The same function can be also performed by a method using a table that is registered in advance without using a cryptograph key. When the point system management company 3 gives the IC card 1 to a customer, table data is added to the point management program 13. A confirmation of the store, which is done by the point management program 13, can be determined by judging whether the store is registered in this table. And, there is another method in which use this table is used for registering the cryptograph key of every manufacturer and store to enable the point management program 13 to decode the cryptograph.

Another way to use the table may be possible. In this case, each manufacturer and store that operate a point system will first access an IC card, writing an element that is a key, such as a cryptograph key into a table area from the reading and writing apparatus. This method can solve the problem that when renewal becomes necessary in such a case, a store is added newly by an original table method.

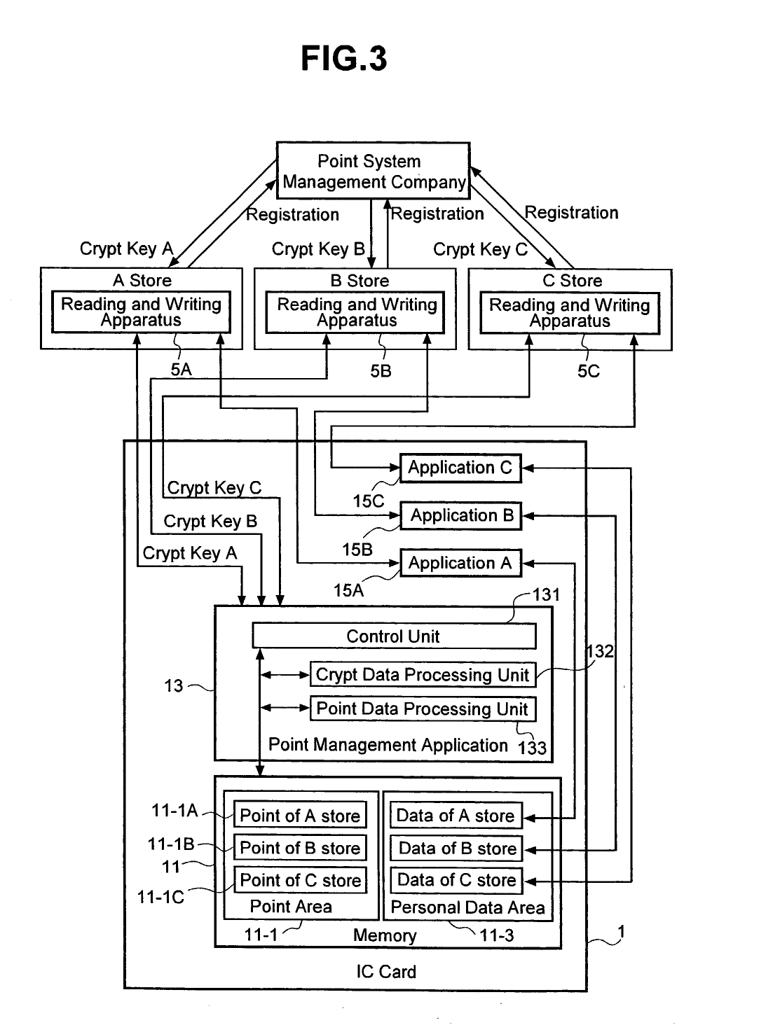

By referring to FIG. 3, the structure of a point management system that represents a second preferred embodiment of a present invention will be explained. This preferred embodiment uses an IC card that can store several applications in an IC memory. In this preferred embodiment, a point system is combined with the method wherein each store has transacted in a conventional way with a customer by using an IC card, etc. The point management system of this preferred embodiment is comprised by an IC card 1 which can store several applications, a point system management company 3 and a reading and writing apparatus 5C of store C, an reading and writing apparatus 5B of store B, and an reading and writing apparatus 5A of store A.

It is possible to store a plurality of applications in the IC card 1. The IC card 1 has a memory 11 for storing points, the point management application 13 provided from the point system management company 3, and a manufacturer application that corresponds to the reading and writing apparatus 5, all of which are provided on the IC card 1. The manufacturer application is the original application of each store to use a service that is peculiar to each store. For example, the application A 15A is for store A, the application B 15B is for store B and the application C 15C is for store C. Memory 11 is also used as a data storage area of an application in the IC card 1. This application is to record data including the number of times of use, the age of a customer and what goods are purchased at each store in a personal data area 11-3.

The point management application 13 has at least two functions. The first function is cryptograph processing involving key data that is used when accessing an application. The second function is managing the storage of points in a memory 11. The point management application 13 has a control unit 131, a cryptograph processing unit 132 and a point processing unit 133. Using several manufacturers' key data or combination data formed of key data and one or more other items of information, the point management application 13 can be used by the reading and writing apparatus 5. The point management application 13 allows a reading and writing operation only from/into a data area that corresponds to the received key data.

The point system management company 3 has a point system management apparatus capable of controlling the whole point system. This point system management apparatus has the function of controlling and managing point data the for store A, the store B and store C, and it has the function of issuing key data that becomes a key that is particular to each store. In case the point management application 13 to be described later is used, that key data is used. In this preferred embodiment, a cryptograph key and a registration store number are returned as key data.

The reading and writing apparatus 5A, 5B and 5C of each store uses the point management application 13 stored in the IC card 1 in the same manner as the first preferred embodiment. And, the reading and writing apparatuses 5A, 5B and 5C also use the manufacturer application that is provided by each store corresponding to each reading and writing apparatus. The relationships between the point system management company 3 and each of store A, store B and store C is the same as that of the first preferred embodiment. And, the function of the point management application 13 is also the same as that of the first preferred embodiment.

When it is confirmed that a customer is a regular customer from the number of times of use by the customer, the application may operate to double the points earned, besides storing individual information in an individual data area. If this application is adopted, a service that is original to the store can be developed. The applications A, B and C have a compliance to a less concrete function than the above.

A credit function will be explained, for example, concerning store A in the above system. The reading and writing apparatus 5A has a function that is necessary for transactions with a credit company. And then, the application A 15A in the card that corresponds to this is accessed by a credit function. This application A 15A has the function of managing the individual data for a reference and control of credit use history. When a customer makes a purchase using credit in the store A, the reading and writing apparatus 5A communicates with the application A 15A, and takes in the data contained on the card, and the data is then sent to the credit card company. If it is possible to proceed with the transaction, the reading and writing apparatus 5A performs a procedure with the credit card company and processes the data in the history of use storage area by accessing the application A 15A. The reading and writing apparatus 5A issues points according to the amount of the use. Then, an application, in which the reading and writing apparatus 5A is accessed, is changed to the point management application 13 from the application A 15A. As described in reference to the first preferred embodiment, point management application 13 adds points to the point area 11-1A of the store A.

As described above, even in a case of shopping by credit in the conventional way, it is possible to manage the points using the same card. And, in case the IC card 1 has the function of storing electronic money, the application A 15A operates as an application for managing electronic money. After paying the price of goods in electronic money, using application A, the point application is accessed, and points are recorded for the purchase.

Then, in the case where the store B is a gas station or a rental store, the example of installing application B 15B in IC card 1 as a proof of membership will be is explained. The reading and writing apparatus 5B of the store B accesses application B 15B of the IC card 1 and acquires member information. After performing a process of rental for the day, the reading and writing apparatus 5B changes to the point management application 13. And then, the reading and writing apparatus 5B writes points according to the transaction in point storage area 11-1B of the store B, and the processing is then ended.

In the type of business that conventionally manages points using stamps, one card can serve both as a proof of membership and a point pasteboard. In addition, if the store C is a penny arcade, an amusement arcade or a gambling store, an example where the application C 15C provides the function of a prepaid card at the time of borrowing money will be explained. The reading and writing apparatus 5C is inserted into a game machine or a coin dispensing machine. When a customer inserts the IC card 1 into the machine, the reading and writing apparatus 5C accesses the application C 15C and acquires a balance for lending of coins. After determining this information, the amount of coins that a customer specifies is dispensed.

The reading and writing apparatus 5C can write point information according to the amount of coins in the point storage area of the store C by the reading and writing apparatus 5C accessing the point management application 13 after the dispensing of coins is completed. The coins obtained in the game are calculated in the coin totalization machine of the store C. By inserting the IC card 1 in this apparatus, the coin totalization machine can access point management application 13 and can calculate the number of coins. The coin totalization equipment writes the point total according to the total number of coins in point storage area 11-1C of the store C, and the process of totaling coins is then ended. The points that are issued in the store C can be exchanged for giveaways, such as tobacco and chocolate, having a value that is equal to the number of coins obtained in the game of the store C. If this invention is used in a store that conventionally manages the number of coins that is used for a giveaway exchange by using a receipt or a magnetic card, the dispensing of coins and totalization of coins can be managed by one card.

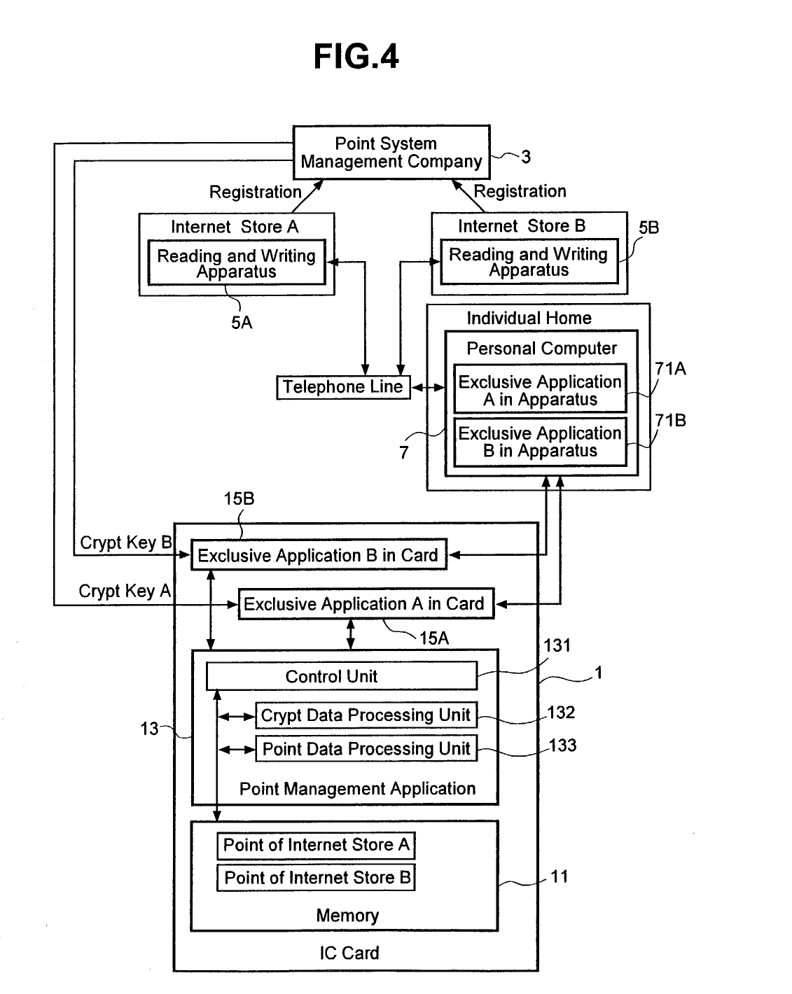

By reference to FIG. 4, the system structure of a point management system for the internet using a telephone line, representing a third preferred embodiment of the present invention, will be explained. This point management system has an IC card 1, a point system management company 3, a reading and writing apparatus 5A in an internet store A, a reading and writing apparatus 5B in an internet store B and a personal computer 7 in an individual home that has an IC card reading and writing apparatus.

The IC card 1 has the point management application 13 provided by the point system management company 3, an exclusive application A 15A in the card for the internet store A to use that is particular to that store and an exclusive application B 15B in the card for the internet store B. The exclusive application A 15A in the card is responsive to a cryptograph key A issued exclusively for the internet store A from the point system management company 3 and has an electronic money settlement of account function. The exclusive application B 15B in the card also is responsive to the cryptograph key B in the same manner as the application A. The IC card 1 has a memory 11 to store a point total. This memory 11 is used as a data storage area of an application in IC card 1.

A personal computer 7 has a machine for reading the IC card 1, an exclusive application A 71A in the apparatus to access an exclusive application that corresponds to the store A and an exclusive application B 71B that corresponds to the store B. That is, the personal computer 7 has the function of accessing an internet store through a telephone line and the function of accessing the application for that internet store in the IC card 1. The internet store has the function of receiving an order from the customer via the telephone line and the function of issuing points according to a fee that is necessary at the time of registration or placing an order.

The relationship between the point system management company 3 and the internet store A or the internet store B is the same that of as the first preferred embodiment. The function of the point management application 13 is also the same as that of the first preferred embodiment. If a customer purchases goods from the internet store A using electronic money, by way of the personal computer 7, in the above system, the customer inserts the IC card 1 in the personal computer 7 and orders the goods via the telephone line. The internet store A, which receives this request, accesses the personal computer 7 using the reading and writing apparatus 5A, and the exclusive application A 15A in the card of IC card 1 is accessed. The exclusive application A 71A in the personal computer 7 controls access to the exclusive application A 15A in the IC card 1 and the reading and writing apparatus 5A in this internet store A.

The reading and writing apparatus 5A of the internet store A transmits price information for the goods to the personal computer 7 and requests a transmission of electronic money from the customer using the IC card 1. When a customer authorizes payment by the personal computer 7, electronic money is transmitted from the exclusive application A 15A in customer's IC card 1 to the reading and writing apparatus A 5A of the internet store A. After receipt of the electronic money is completed, the internet store A issues points according to the price of the goods through the personal computer. Because points are transmitted through a telephone line, the point may be tapped and falsified. To prevent the tapping and falsification of the transmission, the points that are issued in the internet store A are processed cryptographically.

The points are sent to the personal computer 7 through a telephone line. The exclusive application A 71A in the personal computer 7 transfers the points to the exclusive application A 15A in the IC card. The exclusive application A 15A in the card decodes the point amount and sends the decoded amount with the cryptograph key A that is particular to the internet store A to the point management application 13. The point management application 13 decodes the transmitted cryptograph key A by a predetermined cryptograph decipherment in the point system management company 3, and stores the points in the area of specification.

In this system, the reading and writing means of personal computer 7, that directly reads and writes an IC card 1, does not have the point issuing function of IC card reading and writing apparatus 5, as described with reference to the above preferred embodiment. Because forgery of points is possible if the function of issuing points is available in the customer's apparatus, the ability to issue points only by the host side is better. The points received by internet shopping can be used as a discount at the time of the next purchase or they can be redeemed for a gift, such as original goods, by performing a reverse procedure.

Now, an example that wherein internet store B is a license issuing organization that issues and manages licenses and their renewal will be explained. The IC card has a renewal application 15B in the card to update a license. When a license renewal request is received through a telephone line from the owner of a license, the internet store B accesses the exclusive application B 71B in the apparatus. The exclusive application B 71B in the apparatus has the function of transmitting and receiving data that is exchanged between the license issuing organization and the renewal application 15B in the card.

The license issuing organization acquires information concerning the license owners, such as a name, birth date, a legal residential address, an issue date and a valid deadline, from renewal application 15B in the IC card 1. After doing a comparison and an interpretation of the information registered by the license issuing organization, the license issuing organization renews a license within a valid deadline. If at the time of renewal, a change of name or legal residence are necessary, the personal computer 7 may be used for inputting this data. And, a license publishing organization can access the database of a public office and record the latest license information. If a certification photograph is necessary, the user connects a digital camera to the personal computer 7 and sends image data to the license publishing organization through the telephone line. The captured image data also is stored in the IC card 1. The ability to draw out electronic image data only by a special method is more effective than sticking a photograph of the user on a license directly, from the point of view of counterfeit prevention. As in the other examples, the renewal cost can be paid in electronic money.

At the time of a license renewal, the license publication organization issues points based on a traffic point system of a license to an area exclusively provided for a license publishing organization in IC card 1. In the typical traffic point system, a specified point amount corresponding to a traffic violation or an accident is given to an offender. When the points reach a certain level, the driver's license will be suspended. The division of motor vehicles increases or decreases the points by considering the driving conditions and the driver's previous convictions. In this preferred embodiment, the points are issued by considering information such as the renewal date, and whether a predetermined period has passed after a violation or not. The license issuing organization issues the points at that time.

In case a driver violates a traffic law, the police communicate from the police vehicle directly a license issuing organization by radio. And then, the police subtract points from the IC card of a driver. Therefore, the point information of a license publication organization and the point information of an IC card can be kept always consistent and up to date. When a driver's license is identified from a police car or a police station, time for processing the data can be shortened in comparison with the reference by another communication, because a reading of the IC card can directly reference the license.

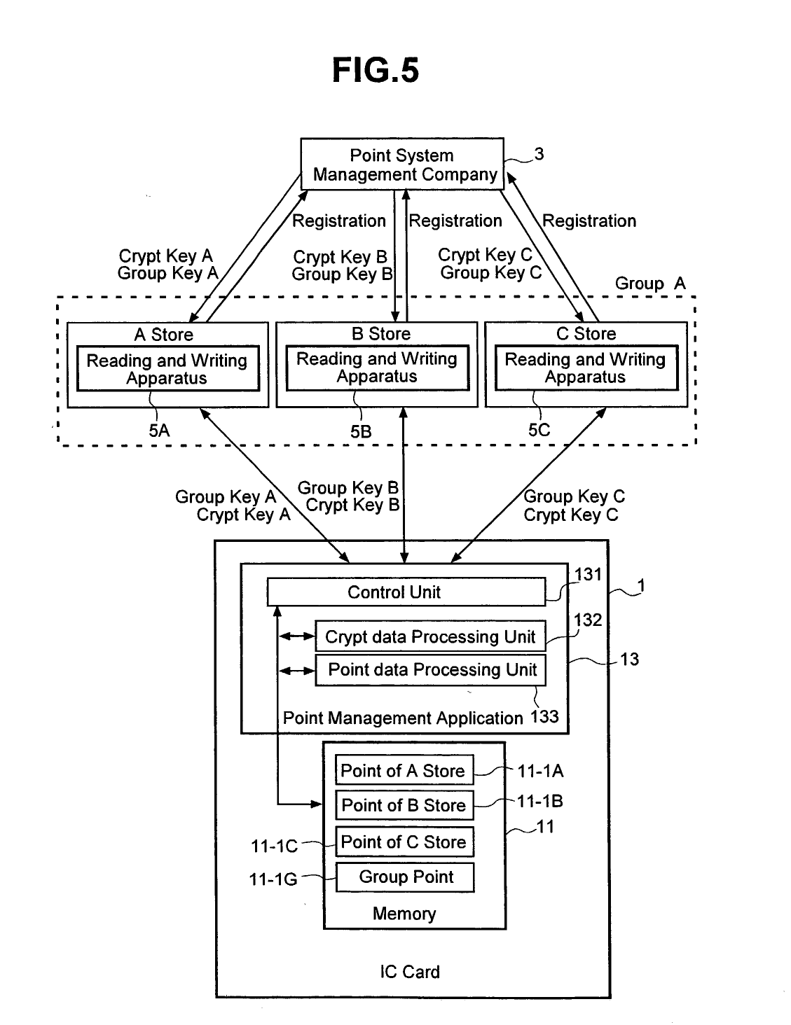

In the above preferred embodiment, the example of a point management system that cannot access the points awarded by other stores was explained. However, points may be commonly used in several stores, by a manufacturer and parties. Referring to FIG. 5, a fourth preferred embodiment will be explained The fourth preferred embodiment is a point management system using points awarded by several stores in common.

In this preferred embodiment, several stores are registered in the point system management and company can jointly use points and issue points. The system structure of the point management of this embodiment is similar to the structure of the first preferred embodiment. However, the memory of this embodiment is different from the memory of the first embodiment. The point storage area of memory 11 is split into point areas 11A-C used exclusively for each store and a group point area 11G that is commonly used in several participating stores. And, the function of the point management apparatus is also different from that of the first embodiment. The point system management apparatus registers data and controls the manufacturer that operates a point system. In addition, the point system management apparatus controls several manufacturers as a group and issues cryptograph key data for a group to access the point management application that is particular to each group.

The point system management company 3 registers the data of the store A, the store B and store C, and issues cryptograph key data, which is particular to each store. Moreover, point system management company 3 issues a group key that is particular to access group points. The group points co-owned in store A, store B and store C can be used in common. And, group points can be issued by each store.

The point management application 13 encodes a group key and has the key data exclusively for each store, and manages points stored in the memory. And, the IC card 1 includes the point management application 13 provided by the point system management company 3 and the memory 11.

When a customer does shopping in the store A using his or her IC card 1, the store A issues points according to the purchase amount of the goods to the IC card 1 of the customer. The reading and writing apparatus 5A of the store A issues points that are particular to the store A and group points that can be used in the store B and the store C simultaneously. The process of memorizing exclusive points for the store A to the IC card 1 is similar to the first preferred embodiment. To issue group points, the reading and writing apparatus 5A sends a group point with a group key A to the point management application 13.

In the same manner as with the points that each store issues, point management application 13 writes group points sent by the apparatus in the group point area 11G of memory 11. By decoding group key A, a group number can be confirmed. A method of managing several groups can use the method of discriminating each store as it is. And, the individual points and the group points of each store can be separately issued. It is also possible to issue points for a store and group points independently. When either type of points is issued, the points can be written to the other type of points automatically by modifying the point management application in the card. When the group of the store A, the store B and the store C implements a promotion to award a prize of an overseas trip, they can use this card. And, in case one group of stores in a shopping mall does a year end lottery sale, the shopping mall can use a card for such a promotion. By each store issuing group points during the term of the promotion, the group points can be used instead of a conventional lottery ticket. The store can do new business, that increases the points of each store during a special sale, and carry out a lottery separately with the group points, because the store can manage group points and each store's points independently.

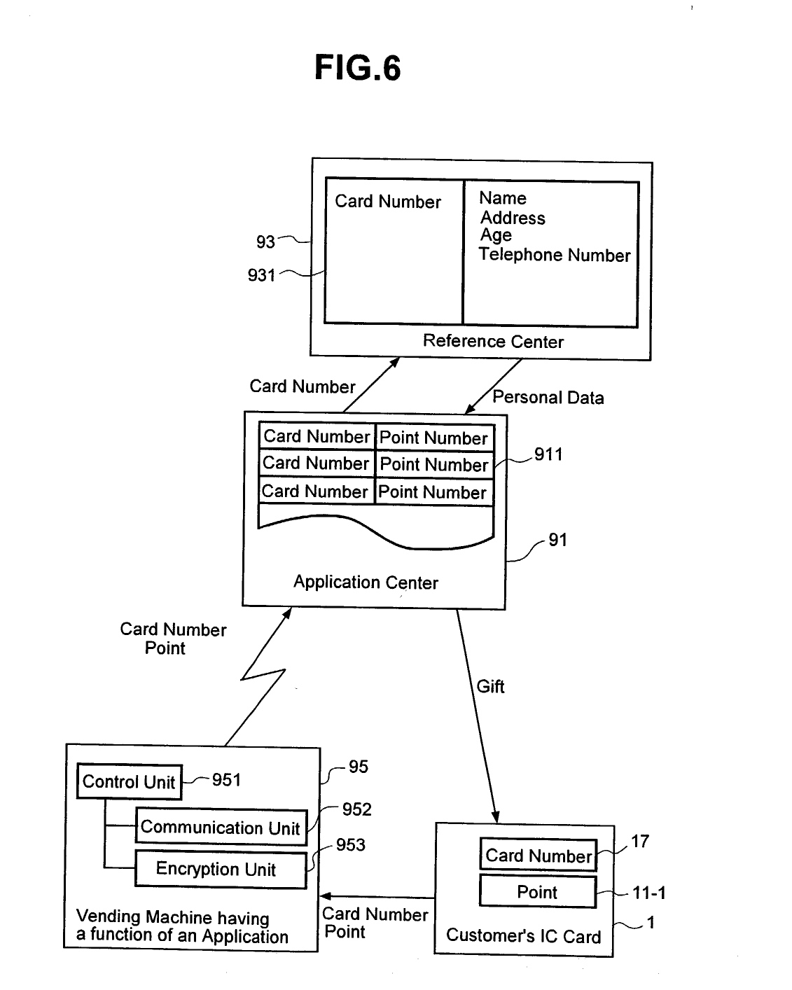

Referring to FIG. 6, a method of using points stored in an IC card according to a fifth preferred embodiment of a present invention will be explained. In this system, like the previous embodiments, when a customer purchases goods in a vending machine and pays a price in electronic money, the application provided by a manufacturer of the vending machine can store the point amount in an area reserved for the manufacturer on the IC card 1. The conventional procedure in which a customer, who has collected seals which a soft drink manufacturer has stuck on a can, applies the seals to a pasteboard becomes unnecessary, because points are accumulated on the IC card automatically when a customer purchases from the vending machine by using the card. Therefore, this method is advantageous for a customer.

When a customer uses saved points as money to obtain a giveaway, a method is used that needs two procedures. First, the terminal device of a manufacturer or a store has to print out the electronic data that shows the number of points recorded on the IC card on paper. Second, a customer has to stick the paper with the printed points on a postal card. After that procedure, the customer can apply for the giveaway. The application of points stored on an IC card by using that method is inconvenient, compared with application by a conventional method of stacking a seal on a pasteboard and mailing it to the promoter of the giveaway. This preferred embodiment solves this problem.

The point management system of this preferred embodiment is comprised of an IC card 1 for a customer, an application center 91 of a manufacturer, a reference center 93 that does individual certification and a vending machine 95. The IC card 1 for a customer has a memory 11 that includes a point storage area 11-1 to store points and a card number 1 that can be used as an ID number to specify an individual. The application center 91 of a manufacturer has an application table 911 which stores the card number 17 and the number of points that correspond to the card number. The reference center 93 has a reference table 931 which stores a card number, the name of the owner of a card, an address, age, a telephone number, etc. The reference center 93 can access the address, the name, etc. of an owner based on the card number. The vending machine 95 has a control unit 951, a communication unit 952 and an encryption unit 953. The vending machine 95 can transmit a card number and a point amount to the application center 91. The vending machine 95 also has a reading and writing apparatus to access the point information of the IC card 1.

In this system, when a customer inserts IC card 1 into the reading and writing apparatus of the vending machine 95 and purchases goods as usual, the vending machine 95 writes points in the area 11-1 of the IC card 1. If the point total reaches a score that makes it possible to redeem points for a gift, vending machine 95 informs the customer that a score has been achieved that makes it possible to obtain a gift. The customer conveys the desire to redeem points to the apparatus by using a button, etc. The vending machine 95 at which a customer has indicated an intention to redeem points will withdraw points from the IC card 1 of the customer. Simultaneously, the vending machine 95 acquires and codes the card number of the card and transmits data, that is, card number data and data of the number of points, to the application center 91. The application center 91 inquires of the reference center 93 about a received card number, gets individual information, such as the address and the name of the card owner, and sends a gift, etc. to the address.

In case of a lottery, the application center 91 holds the points and the card number of a customer until a lottery day and inquires of the reference (individual certification) center 93 about the card number only of a prizewinner.

In this preferred embodiment, one manufacturer can deal with several kinds of points. During a limited term promotion, a customer can participate by storing points for only the term separately from points earned at the time of a normal purchase.

By using a leased line between the vending machine 95 and the application center 91, safety at the time of data transmission can be improved. On the contrary, by connecting this application center 91 via a general telephone line, the customer can participate by using the personal computer and the telephone that are in his or her home. That is, the privacy of use can be improved.

The application center 91, as well as the reading and writing apparatuses, such as the vending machine and the personal computer terminal, can read out data from the IC card 1. Of course, the reading and writing apparatus in a store can have this function as well. By the way, in the conventional point system using a seal, etc, points can be exchanged between individuals easily. The point data stored in an IC card is electronic information. Therefore, it is possible to transmit point data between individuals, as electronic money can be transmitted.

The terms “manufacturer” or “store” used in this specification refer not only to an organization that manufactures or sells material goods, but also to a bank or a restaurant that provide a service or an organization that provides non-tangible goods, such as information. In addition, these terms may refer to a public organization that provides an administrative service, etc.

Conventionally, a manufacturer or store has provided points to a customer by various methods, and therefore, the customer has had a problem of having to manage many kinds of pasteboards or cards. The collected were stuck on a pasteboard or a postal card by the customer and mailed, except for those used in the store in exchange for goods, etc. The present invention can solve such conventional problems. The points provided by several manufacturers and stores can be managed one card by using this invention.

In addition, group points, which are managed in common by the related companies, can also be managed by one card separately from the points of each store or manufacturer according to the present invention.

And, according to the present invention, by transmitting points recorded on a card, points collected by a customer can be sent.

In the IC card, which has several applications according to the present invention, the operation of other applications using the card and a point management application can cooperate. By this cooperation, payment and point acceptance can be can be carried out using one card.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications a fall within the ambit of the appended claims.

What is claimed is:

1. A point management system comprising:
an IC card having a memory storing a card number and point data which is assigned corresponding to a customer's use;
a reference center which references the card number and customer's data;
a reader and writer which reads the card number and the point data from said IC card and transmits the card number and the point data; and
an application center which receives the card number and the point data, holds the card number and the point data, conducts a lottery, and sends a gift to a winner of the lottery based on information of said reference center.

2. A method of point service using saved points stored in an IC card, comprising the steps of:
receiving a card number and point data which are transmitted after reading out from said IC card;
holding the card number and the point data;
conducting a lottery; and
sending a gift to a winner of the lottery based on information provided by a reference center which references the card number and the point data.

3. A method of applying by using saved points stored in an IC card, comprising the steps of:
having said IC card inserted into a reader and writer,
wherein said IC card includes a memory storing a card number and point data which is assigned corresponding to a customer's use;
reading a card number and point data from said IC card; and
transmitting the card number and the point data to an application center which receives and holds the card number and the point data, conducts a lottery, and sends a gift to a winner of the lottery based on information provided by a reference center which references the card number and the point data.
